(19) United States
(12) Patent Application Publication
(10) Pub. No.: US 2009/0113175 A1
(43) Pub. Date: Apr. 30, 2009

(54) Processor architecture for concurrently fetching data and instructions

(75) Inventors: Yuqian Wong, San Diego, CA (US); Junfeng Wang, San Diego, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 11/980,026

(22) Filed: Oct. 30, 2007

(51) Int. Cl. G06F 9/30; G06F 15/76

(52) U.S. Cl. 712/36; 712/E09.016

(57) ABSTRACT

In one embodiment, a processor architecture for concurrently fetching data and patched instructions includes a microprocessor, an instruction patch, a dedicated instruction memory, a patch memory, and a dedicated data memory. The instruction patch is coupled to the microprocessor by an instruction bus, and is also coupled to the dedicated instruction memory and the patch memory. The patch memory and the dedicated data memory are coupled to the microprocessor by a data bus separate from the instruction bus. In one embodiment, the instruction patch has a number of comparators that can be individually enabled by respective enable signals. Each comparator that is enabled compares every bit on an instruction address with a corresponding bit of a patched instruction address to detect a patch condition. When a patch condition is detected, patched instructions are fetched from the patch memory, while the microprocessor can concurrently fetch data from the dedicated data memory.

### BACKGROUND OF THE INVENTION

1. Field of the Invention

The present invention is generally in the field of processors. More particularly, the invention is in the field of processor architecture.

2. Background Art

Many electronic applications rely on processors for their computing power and flexibility. Product examples of processor-based applications include, but are not limited to, desktop personal computers, laptop computers, personal digital assistants, handheld calculators, laser printers, and fax machines.

Processor-based applications require dedicated instruction memory to operate. Typically, dedicated instruction memory resides in a non-volatile memory such as, for example, read-only memory (ROM) in order to minimize power consumption, enhance reliability, and reduce manufacturing costs. However, a major limitation of using ROM to store dedicated instruction memory is the inability to make any modifications to the dedicated instruction memory once the processor-based application has been fabricated. Patched instructions are commonly used by those skilled in the art to allow changes or upgrades to the processor-based application, thus adding to the flexibility and lifetime of the processor-based application.

“Patched instructions” is a phrase used in the present application to refer to instructions that are to replace outdated and/or defective ROM instructions. Conventionally, the microprocessor fetches the patched instructions from a random access memory (RAM) to replace outdated and/or defective instructions in the ROM. However, the RAM is also used to store data needed by the microprocessor. Thus, one limitation of this conventional approach is that the microprocessor must cease fetching data from the RAM whenever patched instructions are being fetched. As such, this conventional approach reduces the microprocessor's data-fetching efficiency, ultimately lowering the overall performance of the processor-based application.

Thus, there is a need in the art for allowing the fetching of patched instructions without reducing the microprocessor's data-fetching efficiency and overall performance of a processor-based application.

### SUMMARY OF THE INVENTION

A processor architecture for concurrently fetching data and instructions as shown in and/or described in connection with at least one of the figures, as set forth more completely in the claims.

### BRIEF DESCRIPTION OF THE DRAWINGS

FIG. 1 shows a diagram of a conventional processor architecture.

FIG. 2 shows a diagram of an exemplary processor architecture for concurrently fetching data and patched instructions, according to an embodiment of the present invention.

FIG. 3 shows a diagram of an exemplary instruction patch for detecting a patch condition and allowing selection of a patched instruction address.

### DETAILED DESCRIPTION OF THE INVENTION

The present invention is directed to a processor architecture for concurrently fetching data and instructions. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

The present invention is a processor for fetching patched instructions, i.e. instructions that are to replace outdated and/or defective ROM instructions, without reducing data-fetching efficiency of the processor. As will be discussed in detail below, this advantage is a result of having a processor architecture and technique that allows concurrent fetching of data and patched instructions.

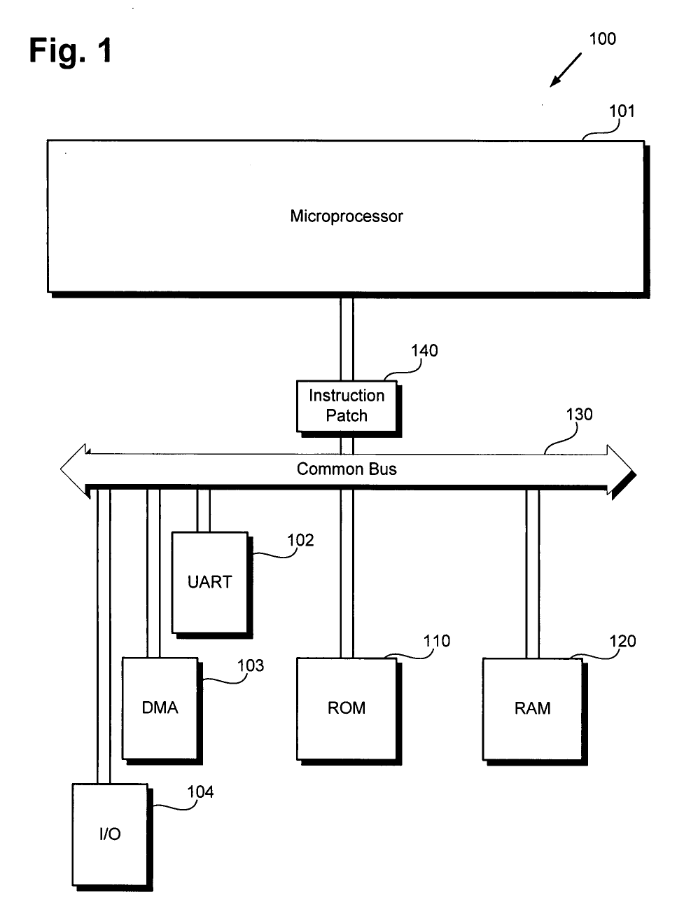

FIG. 1 shows a diagram of an exemplary conventional processor architecture for fetching patched instructions. Processor architecture 100 includes microprocessor 101, instruction patch 140, read-only memory (ROM) 110, random-access memory (RAM) 120, and exemplary system modules (universal asynchronous receiver/transmitter) (UART) 102, direct memory access (DMA) 103, and input/output (I/O) 104. ROM 110, RAM 120 and exemplary system modules UART 102, DMA 103, and I/O 104 are able to exchange data with microprocessor 101 via common bus 130. UART 102, DMA 103, and I/O 104 are merely non-exhaustive examples of various system modules that may exist and may communicate with microprocessor 101, and additional or different system modules may exist in conventional processor architecture 100, as known to those of ordinary skill in the art.

According to the conventional processor architecture, as exemplified by processor architecture 100, dedicated instruction memory typically resides in ROM 110. The dedicated instruction memory cannot be modified after production. Patched instructions, on the other hand, resides in RAM 120 so that it may be modified or re-written as necessary. Patched instructions are typically necessary to accommodate new and/or different features requested by various customers or when ROM 110 has defective bits, columns, or rows. Thus, patched instructions allow easy accommodation of instruction changes and also provide a certain degree of redundancy.

The reading of a dedicated instruction memory, such as ROM 110, by microprocessor 101 during operation is regulated by instruction patch 140. Processor architecture 100 allows patched instructions residing in RAM 120 to be read in seamlessly with the instructions residing in the dedicated instruction memory, i.e. instructions residing in ROM 110. Typically, instruction patch 140 allows dedicated instruction memory ROM 110 to be read by microprocessor 101 via common bus 130 until a patch condition is detected. A patch condition is detected by instruction patch 140 when an instruction address outputted by microprocessor 101 matches a “patched instruction address.” A patched instruction address is an address that is typically stored in or otherwise accessible by instruction patch 140, which address informs instruction patch 140 that a certain ROM 110 address contains an outdated and/or defective instruction. Upon the occurrence of a patch condition, instruction patch 140 will direct and allow a patched instruction from RAM 120 to be read by microprocessor 101.

Common bus 130 is the communication path between microprocessor 101 and RAM 120. Thus, when patched instructions are being read from RAM 120 by microprocessor 101, data residing in RAM 120 cannot be accessed by microprocessor 101. As a result, every patch condition detected by instruction patch 140 reduces the efficiency of data transfer from RAM 120 to microprocessor 101.

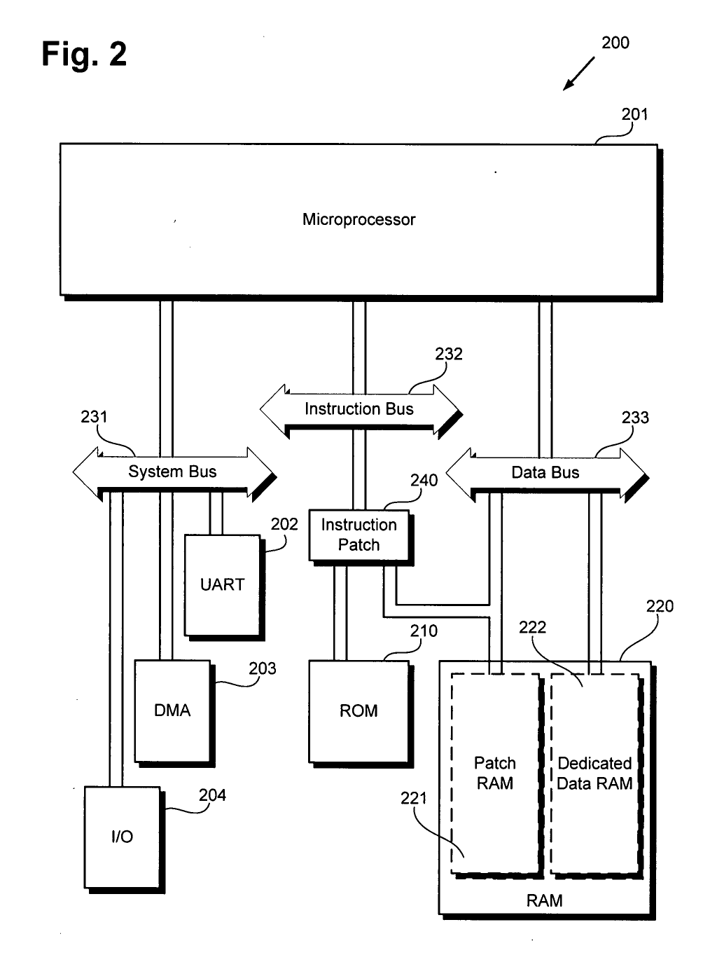

FIG. 2 shows a diagram of an exemplary processor architecture according to one embodiment of the present invention. Processor architecture 200 includes microprocessor 201 and instruction patch 240. Processor architecture 200 further includes exemplary system modules UART 202, DMA 203 and I/O 204. These system modules are analogous to UART 102, DMA 103, and I/O 104 of processor architecture 100 in FIG. 1. As with processor architecture 100 in FIG. 1, UART 202, DMA 203, and I/O 204 are merely non-exhaustive examples of various system modules that may exist and may communicate with microprocessor 201, and additional or different system modules may exist in the invention's processor architecture 200 that are not specifically illustrated to preserve brevity, but are known to those of ordinary skill in the art. Processor architecture 200 of FIG. 2 also includes ROM 210 which is used to store instructions for microprocessor 201, analogous to ROM 110 of processor architecture 100 in FIG. 1.

According to an embodiment of the present invention depicted by processor architecture 200 of FIG. 2, UART 202, DMA 203 and I/O 204 communicate with microprocessor 201 via system bus 231. ROM 210 communicates with microprocessor 201 via instruction bus 232 and RAM 220 communicates with microprocessor 201 via data bus 233. Significantly, instruction bus 232 is a bus separate from data bus 233. In the present embodiment, dedicated instruction memory resides in ROM 210. In this embodiment, “patch memory,” i.e. memory utilized to store patched instructions, resides in patch RAM 221. Dedicated data memory resides in dedicated data RAM 222. As shown in processor architecture 200, in the present embodiment, both patch RAM 221 and dedicated data RAM 222 are part of RAM 220.

Instruction patch 240 regulates and directs the reading of the dedicated instruction memory, i.e. ROM 210 in the present embodiment, as well as the separate reading of patched instructions in patch RAM 221, by microprocessor 201. Instruction patch 240 allows for patched instructions residing in patch RAM 221 to be read in seamlessly with instructions residing in ROM 210 upon the detection of a patch condition.

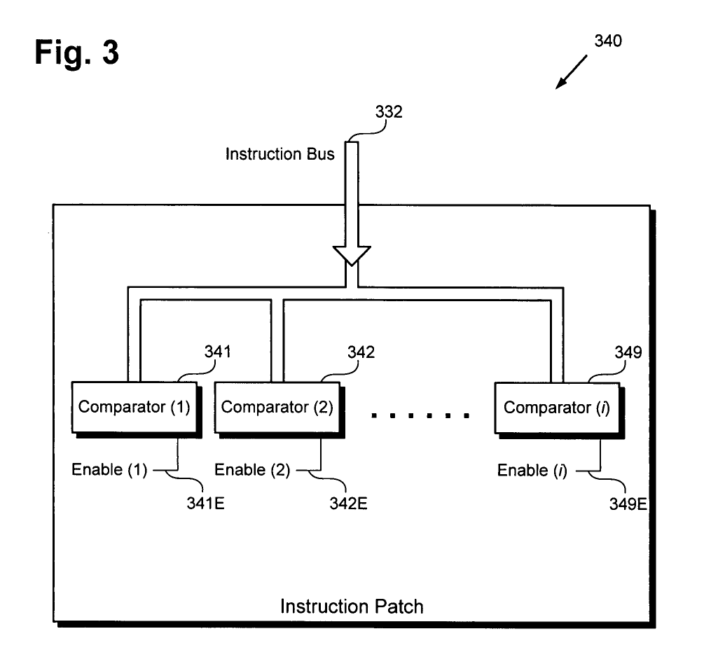

A patch condition is detected by instruction patch 240 when an instruction address outputted by microprocessor 201 matches a patched instruction address. A patched instruction address is an address that is stored in comparators within instruction patch 240 of the present invention, as described in more detail in relation to instruction patch 340 in FIG. 3. A stored patch instruction address alerts instruction patch 240 that a certain ROM 210 address contains an outdated and/or defective instruction. Upon the occurrence of a patch condition, instruction patch 240 will direct and allow a patched instruction from patch RAM 221 to be read by microprocessor 201 through instruction bus 232, without stopping the data fetching operation of microprocessor 201 that utilizes dedicated data RAM 222 and data bus 233.

Thus, processor architecture 200 advantageously enables microprocessor 201 to fetch patched instructions from patch RAM 221 via instruction bus 232 while leaving data bus 233 available for the transfer of data from dedicated data RAM 222. As such, processor architecture 200 increases parallelism, speed, and data transfer capability by enabling concurrent fetching of data and patched instructions.

It is noted that although patch RAM 221 contains patched instructions, data may be stored in any unused capacity of patch RAM 221 to increase the resource capacity of microprocessor 201 and to augment the data memory available through dedicated data RAM 222. This feature for flexibly augmenting data storage capacity is possible due to the present invention's novel processor architecture 200, allowing patch RAM 221 and microprocessor 201 to communicate via data bus 233, as a data bus separate from instruction bus 232. Thus, the present invention advantageously features the availability of increased data memory depending on the size of patch memory actually utilized to accommodate patched instructions. In other words, for applications where the number of outdated and/or defective ROM instructions is small, a greater amount of patch RAM 221 can be used as data memory.

FIG. 3 shows a diagram of the invention's instruction patch 340 corresponding to instruction patch 240 of FIG. 2. In FIG. 3, instruction bus 332 corresponds to instruction bus 232 in FIG. 2. According to this embodiment, instruction patch 340 includes an array of comparators comprising of comparator (1) through comparator (i), which are also referred to as comparator 341, and comparator 324 through comparator 349 as shown in FIG. 3. The number of comparators used in instruction patch 340 is a design choice and can be any number, for example 32, 60, or 100. In general, the number of comparators in instruction patch 340 corresponds to the maximum number of outdated and/or defective instructions in ROM 210 to be replaced by replacement instructions, i.e. by patched instructions in patch RAM 221. For example, 60 comparators are needed to accommodate the patching of a maximum of 60 instructions. Generally, each comparator can store a patched instruction address, that is address of an instruction in patch RAM 221, which instruction is to replace a defective and/or outdated ROM instruction. Thus, the greater the number of comparators 341 through 349, the greater the number of patched instructions that can replace defective and/or outdated instructions in ROM 210. As such, it is apparent that the number of comparators shown in instruction patch 340 or otherwise discussed in the present application is merely for the purpose of a specific example and the actual number of comparators can vary greatly.

The present invention provides great flexibility and power saving by providing precise control over the number of active (i.e. enabled) comparators, so that the number of active comparators matches the exact number of defective and/or outdated ROM instructions that are to be patched. For example, when a system designer or a customer knows that only 55 instructions are to be patched, only 55 comparators are needed (where each comparator stores a single patched instruction address). Thus, while a much larger number of comparators, for example 128 comparators, might be present in instruction patch 340, only some of those comparators, i.e. as many as are necessary to accommodate all the patched instructions, are enabled (in this example only 55 comparators are enabled). The disabling of the unnecessary comparators provides great power savings, since each enabled comparator evaluates and compares every bit of a multi-bit instruction address against a corresponding bit of a patched instruction address that is pre-stored in the comparator. Thus, each comparator that is unnecessarily active would consume a large amount of power in comparing a large number of instruction bits to no end since no match would ever be found. As such, the flexibility to disable any number of comparators (1) through (i) in instruction patch 340 results in significant power savings.

According to one embodiment, each comparator may be enabled (or disabled) individually through its respective enable signal, enable (1) through enable (i), also referred to as enable 341E through enable 349E in FIG. 3. For each comparator that is enabled, a patch condition is detected when that comparator compares each bit of an instruction address from instruction bus 332 with a corresponding bit of a patched instruction address pre-stored in the comparator. For example, when 55 comparators are enabled and instruction bus 332 is a 32-bit wide instruction bus, each of the 55 enabled comparators performs a 32-bit comparison between the instruction address present on instruction bus 332 with a 32-bit patched instruction address pre-stored in the comparator. Disabled comparators do not perform a compare operation on any of the 32 bits. When an enabled comparator detects a match for all of the 32 bits, a patch condition has been detected for a particular instruction address, and a patched instruction from patch RAM 221 will be fetched by microprocessor 201 through instruction bus 232, while the defective and/or outdated instruction stored at the instruction address in ROM 210 will not be fetched. In summary, a significant amount of power would be conserved by enabling only the exact number of comparators necessary to accommodate a given number of patched instructions. It is noted that the exact number of instructions to be patched is known to a system designer or a customer prior to making a decision as to the number of comparators that are to be enabled (or disabled). Moreover, a 32-bit instruction address was used only as an example, and the present invention is not limited to any particular length of an instruction address.

As described above, the present invention provides a processor architecture for concurrently fetching patched instructions and data. Advantages of the present invention over conventional processor architectures include increased parallelism, improved processing speed and efficiency, as well as reduced power consumption. From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a processor architecture for concurrently fetching data and instructions has been described.

1. A processor architecture for concurrently fetching data and patched instructions, said processor architecture comprising:
a microprocessor coupled to an instruction patch by an instruction bus, said instruction patch being coupled to a dedicated instruction memory and a patch memory;
said microprocessor being coupled to a dedicated data memory by a data bus separate from said instruction bus, wherein upon detection of a patch condition, said microprocessor is capable of fetching said patched instructions from said patch memory while concurrently fetching said data from said dedicated data memory.

2. The processor architecture of claim 1 wherein said patch condition is detected by said instruction patch when an instruction address outputted by said microprocessor matches a patched instruction address.

3. The processor architecture of claim 1 wherein said dedicated instruction memory resides in a read only memory (ROM).

4. The processor architecture of claim 1 wherein said patch memory resides in a patch random access memory (RAM).

5. The processor architecture of claim 1 wherein said dedicated data memory resides in a dedicated data random access memory (RAM).

6. The processor architecture of claim 1 wherein said patch memory and said dedicated data memory reside in a same random access memory (RAM).

7. The processor architecture of claim 2 wherein said instruction patch utilizes at least one comparator for comparing each bit of said instruction address with a corresponding bit in said patched instruction address to detect said patch condition.

8. The process architecture of claim 7 wherein said at least one comparator can be selectively activated using an enable signal.

9. The processor architecture of claim 2 wherein said instruction patch utilizes a first plurality of comparators, said first plurality of comparators being greater than a plurality of said patched instructions.

10. The processor architecture of claim 9 wherein a second plurality of comparators are enabled, said second plurality being less than said first plurality.

11. The processor architecture of claim 9 wherein a second plurality of comparators are enabled, said second plurality of enabled comparators being equal to said plurality of said patched instructions.

12. An instruction patch for detecting a patch condition and allowing selection of a patched instruction address, said instruction patch comprising:
at least one comparator for comparing each bit of an instruction address with a corresponding bit in a patched instruction address;
said at least one comparator being controlled with an enable signal;
wherein said patch condition is detected when said at least one comparator is enabled and when said instruction address matches said patched instruction address.

13. The instruction patch of claim 12 wherein said instruction address is provided by an instruction bus coupled to said instruction patch.

14. The instruction patch of claim 12 wherein said at least one comparator is one of a first plurality of comparators, said first plurality of comparators being greater than a plurality of patched instructions.

15. The instruction patch of claim 14 wherein a second plurality of comparators are enabled, said second plurality being less than said first plurality.

16. The instruction patch of claim 14 wherein a second plurality of comparators are enabled, said second plurality of enabled comparators being equal to said plurality of patched instructions.

17. The instruction patch of claim 12 wherein said instruction patch is coupled to a dedicated instruction memory.

18. The instruction patch of claim 17 wherein said dedicated instruction memory resides in a read only memory (ROM).

19. The instruction patch of claim 12 wherein said instruction patch is coupled to a patch memory.

20. The instruction patch of claim 19 wherein said patch memory resides in a patch random access memory (RAM).
